(19) United States
(12) Patent Application Publication
(10) Pub. No.: US 2012/0303403 A1
(43) Pub. Date: Nov. 29, 2012

(54) INTERACTIVE, REAL-TIME SYSTEM AND METHOD FOR MONITORING PROFESSIONAL FEES

(76) Inventors: Charlie LEE, Great Falls, VA (US); Robert Moore, Leesburg, VA (US)

(21) Appl. No.: 13/472,652

(22) Filed: May 16, 2012

Related U.S. Application Data
(60) Provisional application No. 61/488,929, filed on May 23, 2011.

(51) Int. Cl. G06Q 10/06

(52) U.S. Cl. 705/7.15

(57) ABSTRACT

A real-time billing monitoring system and method. A processor receiving time data with respect to a task. The time data measures an amount of work accruing by one or more staff members toward completion of the task as the task is being performed. The processor generates a graphical object representing the time data as the task is being performed. The object is displayed on a display device concurrently with the performance of the task.

### CROSS REFERENCE TO RELATED APPLICATION

This application claims the benefit of priority to U.S. Provisional Application No. 61/488,929 filed May 23, 2011, the entire contents of which is incorporated herein by reference.

### BACKGROUND

Billing systems typically collect data from users and record the data in a central location. Such “time and billing” systems are used by professionals in many areas. Architects, consultants of all types and lawyers, to name but a few, typically use such systems and report on a periodic basis (monthly, weekly, quarterly etc.) on the activities performed on behalf of a client.

For example, and without limiting the scope of the claims associated herewith, billing systems geared for use by a law firm will typically collect an amount of time an attorney works on a case and a description of what work was performed. The data collected from all users (attorneys, paralegals, and support staff) may be manipulated to provide a record of the time spent by individuals and/or an organization on a particular project matter or on work for a particular client. These systems thus provide an after-the-fact view of the amount of time spent on any particular matter.

The client typically first learns of the time spent on a matter or case and the hourly fees associated with that time when an invoice is received by the client. Invoices are typically generated on a monthly basis and may not be received by the client for weeks after time has been spent and fees recorded on a matter.

Some billing systems may permit access to data reflecting time entered and billed for a project and the costs associated with that time before the billing cycle is completed. Even under these circumstances, the billing system provides an after-the-fact view of time that has been earlier entered.

### SUMMARY

Embodiments herein provide systems and methods that are directed to providing a client the ability to manage and monitor professional fees, herein referred to as “legal fees” for illustrative purposes only, as they are being accrued on an interactive, real time basis. In an embodiment, a client receives a notice that activity on a particular matter has begun. In another embodiment, the client receives a link to a graphical representation of the time accrued and fees associated with that time as the work is actually being done on behalf of the client together with graphic information on budget limits. Clients can thus manage and monitor work on a matter on an interactive, real time basis without having to wait until a monthly invoice is generated a few weeks after the month in which the work was done. In this way, a client may monitor activities on the client's behalf to ensure progress on important tasks, mitigate improper after-the-fact excessive, double, and value billing by the suppliers of legal or professional services.

### DESCRIPTION OF DRAWINGS

FIG. 1 is a block diagram illustrating a real-time bill monitor according to an embodiment.

FIG. 2 is an illustration of a graphical representation of time accrued to a matter provided by a real-time bill monitor according to an embodiment.

FIG. 3 is an illustration of a graphical representation of fees billed to a project provided by a real-time bill monitor according to an embodiment.

FIG. 4 is a graphical representation of the utilization of a real-time bill monitor according to an embodiment.

FIG. 5 is a graphical representation of the utilization of a real-time bill monitor from the perspective of a client user according to an embodiment.

FIG. 6 is a perspective view of a computing device suitable for use as a personal computing device in various aspects.

FIG. 7 is a perspective view of a computing device suitable for use as a server in various aspects.

### DETAILED DESCRIPTION

The following description describes an embodiment in which a real-time bill monitor is used in a legal context to provide a client the ability to manage and monitor legal fees as they are being accrued by staff members of a law firm on an interactive, real time basis. This description is intended to be illustrative of other businesses and professional organizations that may benefit from bill monitoring in real time and is not intended to be limiting.

As used herein, the term “staff” encompasses attorneys, paralegals, and other employees whose time may be billed on an hourly basis for providing legal services.

In an embodiment, a client receives immediate notice that activity on a particular matter has begun. In another embodiment, the client receives a link to a graphical representation of the time accrued and fees associated with that time as the work is actually being done on behalf of the client.

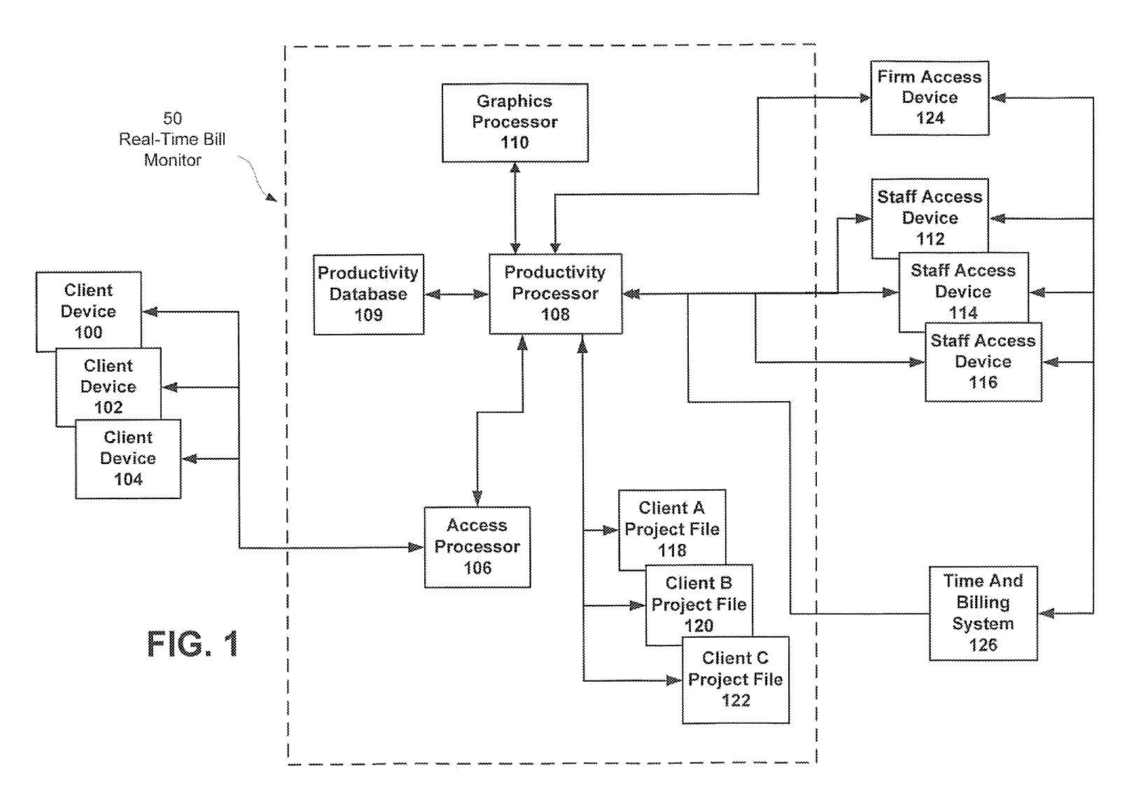

FIG. 1 is a block diagram illustrating a real-time bill monitor according to an embodiment.

In an embodiment, clients A, B and C access a real time bill monitor 50 via client user devices 100, 102 and 104, respectively. Such devices may be, without limitation, desktop computers, laptop computers, tablet computers, smartphones or any other suitable computing devices. While three client user devices are illustrated, the real-time bill monitor system may be accessed by any number of client user devices and clients. In an embodiment, each client provides authentication and authorization information to an access processor 106 prior to being permitted access to the real time bill monitor 50.

A client user device interacts with an access processor 106. The access processor 106 is configured with instructions allowing the processor to accept user input and interact with a productivity processor 108. The productivity processor 108 is configured with computer instructions causing the processor to execute functions that allow one or more projects or matters to be established for the client, and to separately bill and graphically represent the time spent on those projects as more fully set forth below. The productivity processor 108 allows the responsible manager who establishes the matter or project, or those authorized to do so such as an accounting or finance manager of the firm, to also establish which staff members are authorized to work on each client matter and to associate these authorizations with the client matter(s). Unless and until a staff member has authorization, the staff member may not bill to a client matter, thus avoiding any “surprise” billings to the client during or after the fact.

As illustrated in FIG. 1, the productivity processor comprises instructions that allow client project files 118, 120 and 122 to be established, as for example for clients A, B, and C respectively. The productivity processor 108 comprises instructions to track each client project file 118, 120 and 122 that is associated with an individual client. While three client project files are illustrated, this is not meant as a limitation. Each client may have multiple projects, each of which can be tracked by the productivity processor 108.

The company/firm assigns and authorizes staff members to work on the client matters. As illustrated in FIG. 1, staff members access a real time bill monitor 50 (collectively within the dotted box 50) via staff access devices 112, 114 and 116. Again, these access devices may be, without limitation, desktop computers, laptop computers, smartphones, tablet computers and any other device that allows a staff member to interface with the productivity processor to enter time. While three staff access devices are illustrated, the real-time bill monitor 50 may be accessed by any number of staff access devices.

Records of the staff members assigned to each project are kept by the productivity processor 108 in a productivity database 109. Each staff member has a billing rate associated with the time spent by that staff member on a particular project. For example, attorneys A1, A2 and A3 using staff access devices 112, 114 and 116, respectively, initiate activity for projects of clients A, B and C. The amount of time, billing rate, total time spent and statistics concerning the total time spent by project (sometime collectively referred to as “time data”), by staff member, and percent completion based on a budget are tabulated by productivity processor 108 and stored in the productivity database 109.

In addition to the billing by staff members noted above, the productivity processor 108 further comprises communication instructions that cause the productivity processor to send a message to the client device(s) 100, 102, 104 (as appropriate) when billing activity against the client's project begins. This serves to notify the client device that such activity for the client has started. In an embodiment, the message may provide the client with a link that may be accessed to view a graphical representation of the work being performed and a link that may be accessed to view a graphical representation of the accrued time data. In yet another embodiment, the message may include a static graphical object that represents the work that has been performed as to the time the message is sent.

The client is then permitted to monitor, via the access processor, attorneys A1, A2 and A3 as their time is being accrued and as fees are accumulated over time. The productivity processor 108 may associate that time and the value of the time based upon the billing rates of the staff members associated with each project and may store that information in the appropriate client project files 118, 120, and 122 for client access and review.

In an embodiment, the productivity processor 108 sends a message for every event relating to the client's account. However, the client, using the client device such as one of client devices 100, 102, 104, may optionally change the frequency of such messages. For example, the client may choose to only receive a message for the first activity of the day on the account but not to receive messages on subsequent activity on the same day. Alternatively, the client may choose to receive a summary email every morning detailing the activities performed for the account on the previous day.

The productivity processor 108 is further connected to a firm access device 124 and further comprises instructions that allow a manager (i.e., the responsible partner for a matter) to monitor the amount of time being accrued and the time value spent by the various staff members. The firm access device 124 allows insight into the financial expenditures and legal fees associated with each client project file 118, 120 and 122. The firm access device 124 may also be used as a staff access device similar to 112, 114 and 116 to enter time data.

The productivity processor 108, comprises instructions that allow the firm access device 124 to permit the manager (i.e., the responsible partner for a matter) to perform administrative functions on the productivity processor 108 such as assigning and authorizing staff members to work on specific client matters, establishing client project files, setting staff billing rates, and setting budget ceilings.

It should be noted that the embodiment illustrated in FIG. 1 may also be accomplished via an interface to an external time and billing system 126 used by the firm. Thus, in an embodiment, when a staff member inputs time in the existing billing system, that time information is also entered into the productivity processor 108.

In an alternative embodiment, when a staff member inputs time in the existing billing system, an interface between the billing system and the productivity processor 108 allows that billing information to be uploaded on a scheduled basis or on an ongoing basis for as long as a matter is open for billing. This time information is communicated to the productivity processor for subsequent display on client devices.

In yet another alternative embodiment, direct access to the productivity processor 108 is first established by the staff members, and the productivity processor 108 transmits information on billing time and value to a billing system via an interface.

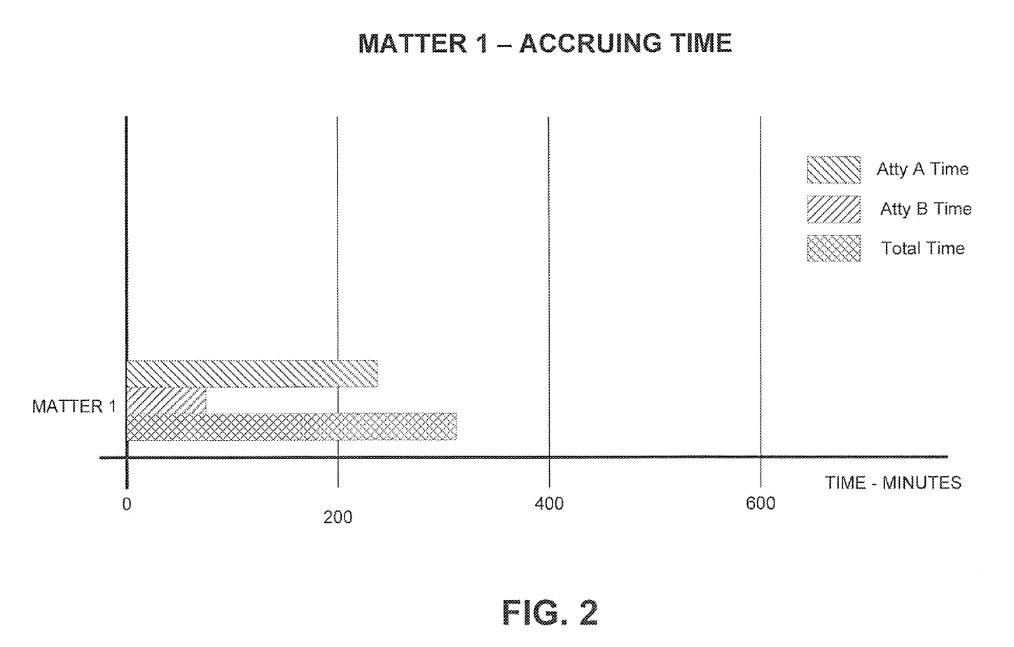

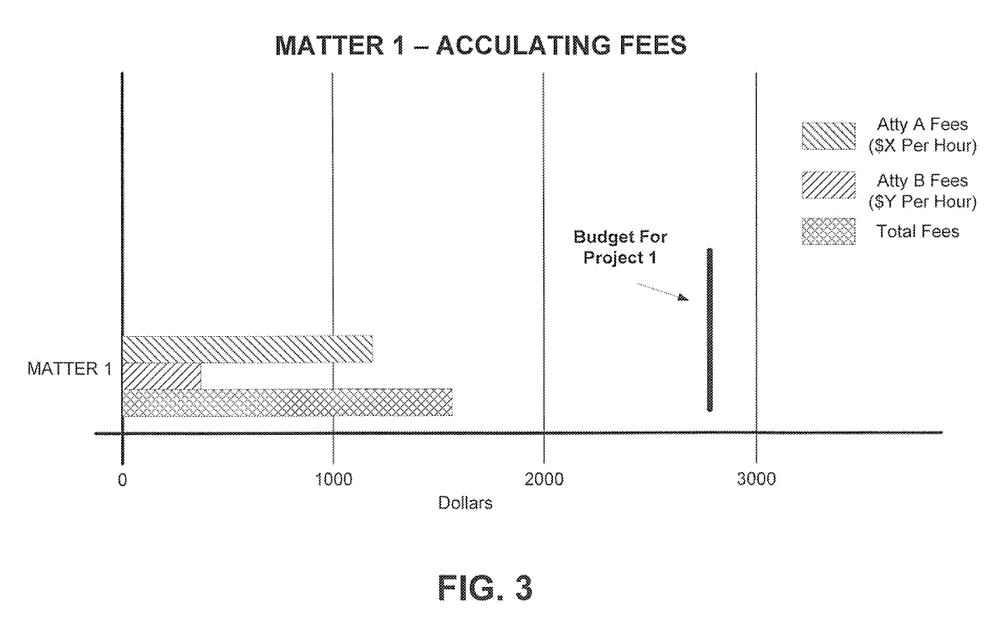

FIG. 2 is an illustration of a graphical representation of time accrual on a matter provided by a real-time bill monitor according to an embodiment. FIG. 3 is an illustration of a graphical representation of fees accumulating on a matter provided by a real-time bill monitor according to an embodiment.

For illustrative purposes, FIG. 2 and FIG. 3 illustrate time accrued and fees accumulated by staff members “Atty A” and “Atty B” assigned to a Matter “1.” However, the illustrations are not meant to be limiting. The real-time bill monitor (50, FIG. 1) may be configured to handle any number of staff members who may be assigned to any number of matters to track time accrual and accumulating fees. More than one matter for the same client may be displayed on the graphical representation.

Referring to FIGS. 1, 2 and 3, in an embodiment, a graphics processor 110 comprises instructions causing the graphics processor 110 to interact with the productivity processor 108 in order to produce a graphical representation of the time that is being, accrued by staff members, such as the staff members using staff access devices 112, 114, and 116 on client projects files 118, 120, and 122. The graphics processor 110 may illustrate the time accrual and the accumulating fees associated with that time as a bar chart as illustrated in FIGS. 2 and 3 or in other graphic manners desired by the client. In short, the bar charts noted in FIGS. 2 and 3 are not meant to be limiting as different clients may want to see other graphic representations known in the art. The time and fees may also be illustrated as a pie chart, a progressing line chart, and any other types of progress charts known in the art. The graphical representations may be displayed in real-time on a firm access device 124 so that firm management can understand the amount of time accrual and the fees accumulating by staff members on client projects in an interactive, real time mode.

In an embodiment, the graphics processor 110 and productivity processor 108 also permit clients, such as clients A, B, and C using client devices 100, 102 and 104, to monitor time and fees that are being accrued and accumulated to a particular project, such as client project files 118, 120 and 122 in real time using links provided by productivity processor 108. In this embodiment, a client, such as client A, uses client device 100 to access the real-time bill monitor 50 via the access processor 106. Client A may then interact with the productivity processor 108 to receive a graphical representation, generated by the graphics processor 110, of the time that is being accrued by staff members, such as the staff members using staff access devices 112, 114, and 116 and fees associated with that time on client A's projects as the time is being accrued. For example, client A may use client device 100 to determine how many attorneys are working on a particular matter of client A's at any given point in time and how much time has been accruing by any specific attorney on that matter, as well as to access other statistics in a graphical or text form.

For example, referring to FIG. 2, a particular client can see that there are two attorneys working on a Matter 1 and the time accrued by each attorney on Matter 1.

Referring to FIG. 3, the graphics processor (110, FIG. 1) comprises instructions for rendering the client fees in an accrual format by each attorney against Matter 1 and the rates charged by each attorney. In addition the charting functionality of the graphics processor (110, FIG. 1) interactively illustrates the total amount of time and money that has accrued and accumulated, respectively, against the particular matter.

As illustrated in FIG. 3, a specific budget amount has optionally been established for Matter 1. The budget for Matter 1 is also illustrated by the graphics processor (110, FIG. 1) so that the client can see in a real-time, interactive fashion how the work is progressing against the budget for the particular project.

In an embodiment, a project may be associated with a budget ceiling by inputting that information to the productivity processor 108 at the time of setting up a client matter or afterwards as desired. The productivity processor also comprises a series of rules for alerting the client associated with the project when certain time and costs benchmarks are met. For example, client A may require notification when expenditures reach 75% of a budgeted amount and client B may require notification when time spent on a project reaches 50% of a budgeted time. Rules may be flexibly established and input to the productivity processor 108 by either the firm access device 124 or the client devices 100, 102, 104 as desired. The notification benchmark may be established for a project or for one or more particular individuals assigned to the project. Notification may be by email, instant message, SMS, or other automated means, and will also be shown on the graphical representation provided to the client if desired.

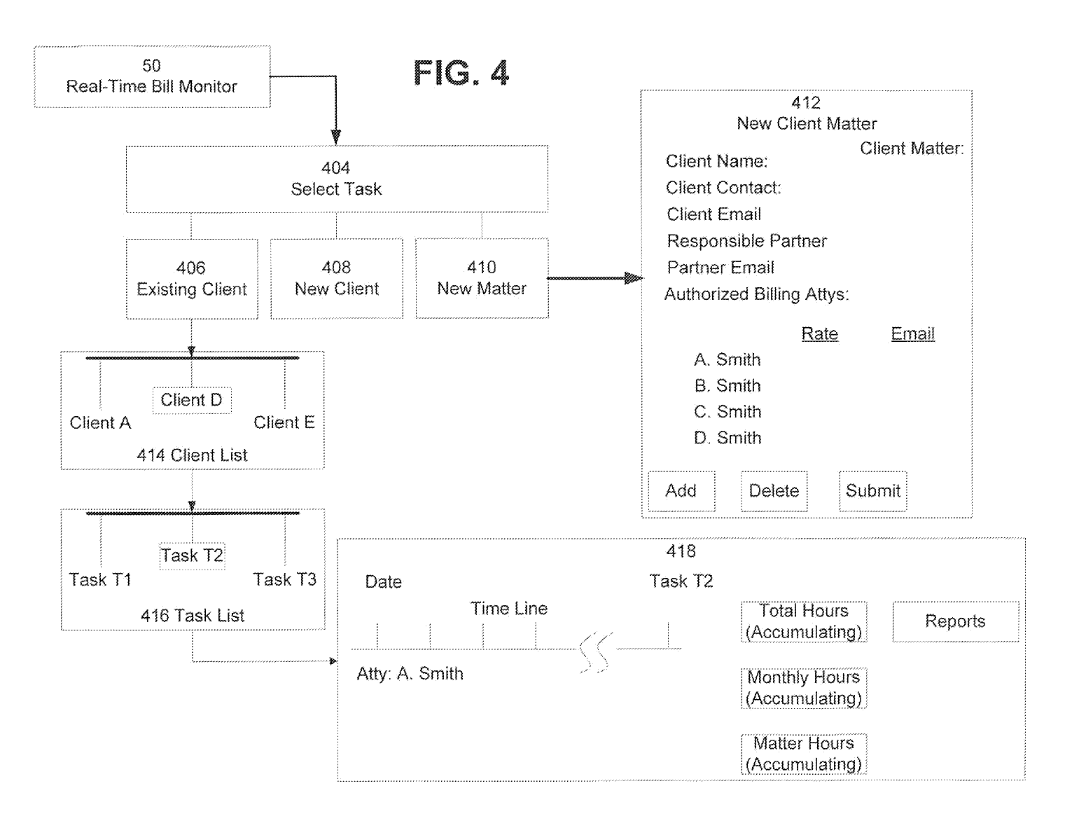

FIG. 4 illustrates the utilization of a real-time bill monitor from the perspective of an attorney according to an embodiment.

An authorized attorney accesses the real-time bill monitor 50 as previously described. In an embodiment, the attorney is prompted to select a task 404. In an embodiment, three tasks are offered by the real-time bill monitor: select an existing client 406, select a new client 408, and select a new matter 410. Other tasks may also be offered.

In an embodiment, the authorized attorney selects “new matter” 410 and is redirected to a new client matter page 412 and prompted to provide information regarding the new matter. As illustrated in Block 412, the new client matter information includes a client name, a matter name, a client contact, a client email address, the name of a responsible partner, the partner email address, and a list of staff members authorized to bill time to the matter, their billing rates and their email addresses. To enter the data into a client project file, such as client project file 118 illustrated in FIG. 1, the attorney selects the “submit” object displayed on the new matter page. In an embodiment, selection of the submit object causes an email to be sent to the client email address that indicates that a new matter has been opened and provides the billing rates for the attorneys authorized to work on the matter. As noted above, this function is not limited to the attorney. New matters or clients may also be established in the system by other authorized users.

In another embodiment, the authorized attorney selects “existing client” 406 and is provided a list of clients 414 from which to choose. By way of illustration and not by way of limitation, the authorized attorney selects client D and is presented a list of tasks associated with client D 416. The authorized attorney selects task T2 and is redirected to a task page and prompted to enter time regarding task T2 418. The entry of the time function triggers an email to the client that activity on task T2 has begun. As illustrated in Block 418, the task page provides a time line displaying the time being entered and cumulative daily, monthly and matter totals. The authorized attorney may also select a reports object. In an embodiment, reports may be requested to provide time entries by day, by month, by year, by project, or by client. A report regarding a matter may include a status of the matter and dates of importance relative to the matter.

While time can be entered as a completed task (e.g. “Finish document editing—0.6 hours”), time can alternatively be entered via a timer where the time is continually updated for the productivity processor 108 and represented by the graphics processor 110.

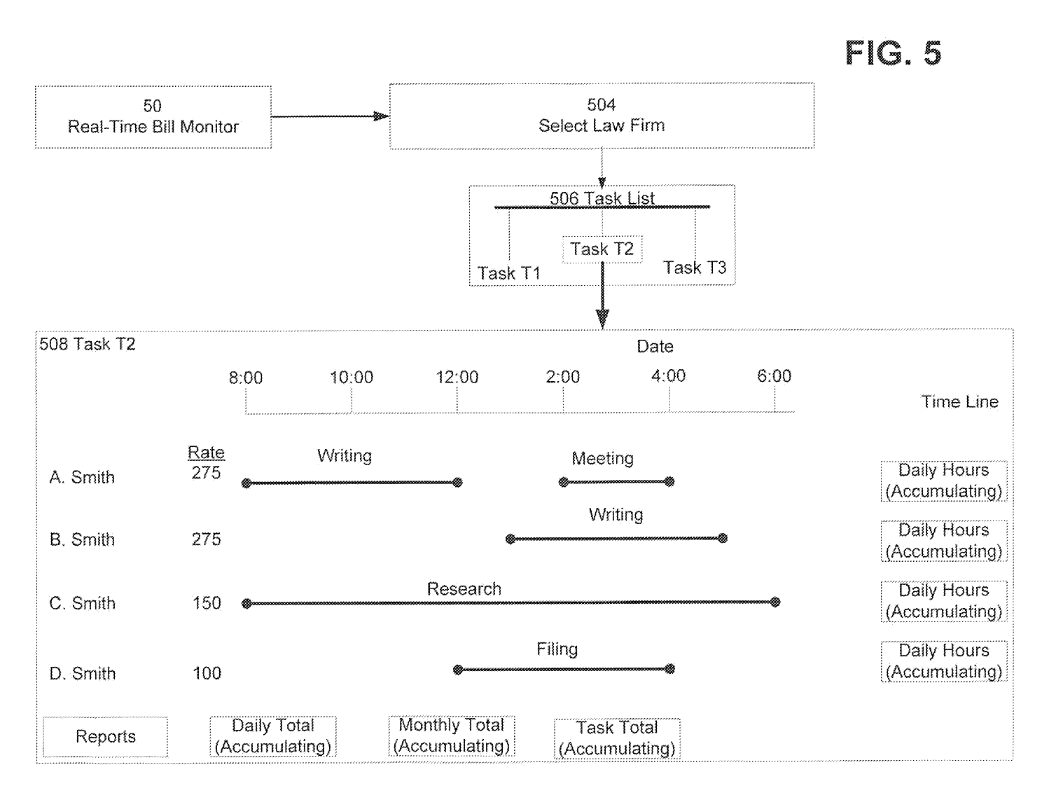

FIG. 5 is a graphical representation of the utilization of a real-time bill monitor from the perspective of a client user according to an embodiment.

In an embodiment, the billing monitor software resides on processors at a number of different firms. The billing monitor interface on the client device allows a client to select the firm at which the client wants to see billing activity. A client accesses the real-time bill monitor 50 as previously described. In an embodiment, the client is prompted to select a law firm 504. Once selection is made, a link is opened to the productivity processor at the selected firm. In another embodiment, the selection of the law firm establishes a secure link between the client access device and the real-time bill monitor. As noted above, the client may also receive a link directly associated with a particular law firm when work has begun on the client's task on any particular day.

By action of the productivity processor (108, FIG. 1), the client is presented a list of tasks associated with the client 506. The client selects task T2 and is redirected to a task page 508. As illustrated in Block 508, the productivity processor together with the graphics processor presents the task page that provides a time line displaying the time being accrued by staff members working on task T2 and the rates of each attorney. The task page also illustrates a cumulative daily, cumulative monthly and cumulative matter totals. The client may also select a reports object. In an embodiment, reports may be requested to provide time entries by day, by month, by year, by project, or by attorney. A report regarding a matter may include a status of the matter and dates of importance relative to the matter. A report regarding an attorney may include biographical information of the attorney.

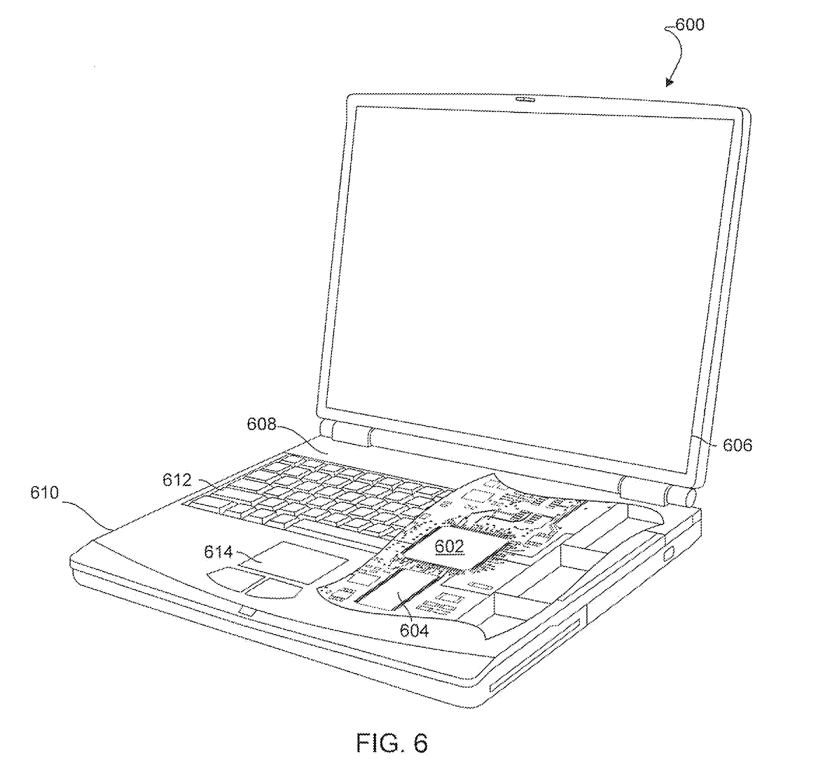

The various embodiments may be implemented in a variety of commercially available computing devices, such as the computing device illustrated in FIG. 6. For example, a computing device as illustrated in FIG. 6 may be used to perform the functions assigned to the client devices, first access devices and staff access devices (see, FIG. 1) A typical personal computing device 600 may include a processor 602 coupled to internal memory 604 and to a display 606. Additionally, the personal computing device 600 may include an antenna 608 for sending and receiving electromagnetic radiation that may be connected to a wireless data link coupled to the processor 602, a wired data connection 610 coupled to the processor 602, and a keyboard 612 and pointing device 614 for receiving user inputs.

The processor 602 may be any programmable microprocessor, microcomputer or multiple processor chip or chips that can be configured by software instructions (applications) to perform a variety of functions, including the functions of the various aspects described above. In some devices, multiple processors 602 may be provided, such as one processor dedicated to wireless communication functions and one processor dedicated to running other applications. Typically, software applications and data may be stored in the internal memory 604 before they are accessed and loaded into the processor 602. The processor 602 may include internal memory sufficient to store the application software instructions. In many devices the internal memory may be a volatile or nonvolatile memory, such as flash memory, or a mixture of both. For the purposes of this description, a general reference to memory refers to memory accessible by the processor 602 including internal memory or removable memory plugged into the device and memory within the processor 602 itself.

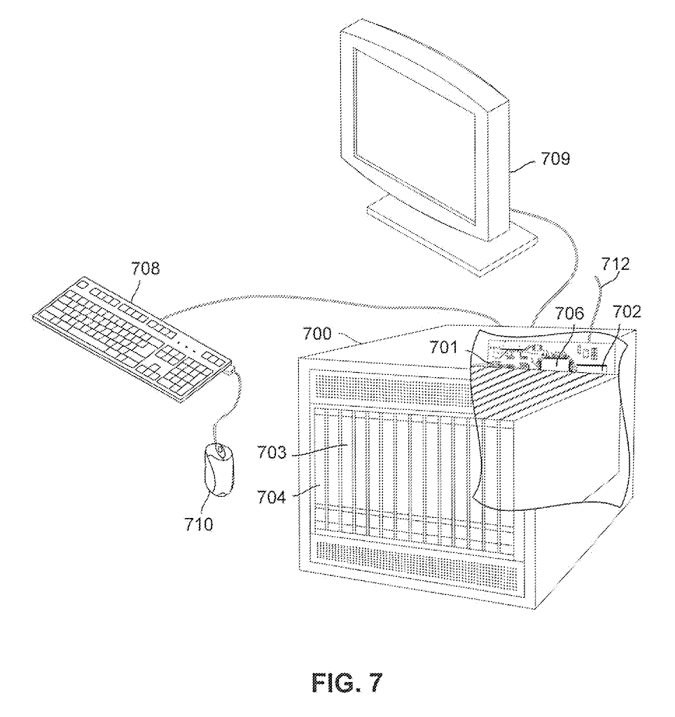

The various embodiments may be implemented on a variety of commercially available servers, such as the example server illustrated in FIG. 7. For example, a server as illustrated in FIG. 7 may be used to perform the functions of a real time bill monitor (see, FIG. 1). A central server 700 typically includes a processor 701 coupled to volatile memory 702 and a lame capacity nonvolatile memory, such as a disk drive 703. The server 700 may also include a floppy disc drive, compact disc (CD) or Digital Versatile Disc (DVD) drive 704 coupled to the processor 701. The server 700 may also include network access ports 706 coupled to the processor 701 for establishing data connections with a network 712, such as a local area network coupled to other broadcast system computers and servers. Servers 700 may also include operator interfaces, such as a keyboard 708, pointer device (e.g., a computer mouse 710), and a display 709.

The foregoing method descriptions and the process flow diagrams are provided merely as illustrative examples and are not intended to require or imply that the operations or steps of the various aspects must be performed in the order presented. As will be appreciated by one of skill in the art the order of blocks in the foregoing aspects may be performed in any order. Words such as “thereafter,” “then,” “next,” etc. are not intended to limit the order of the operations or steps; these words are simply used to guide the reader through the description of the methods. Further, any reference to claim elements in the singular, for example, using the articles “a,” “an” or “the,” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The aspect methods described herein may be implemented in a computing device by configuring a processor of the computing device with processor-executable instructions to perform the operations of the method. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the operations and functions described may be implemented in hardware, software, firmware, or any combination thereof. If implemented in software, the functions may be stored on or transmitted over as one or more instructions or code on a non-transitory computer-readable medium. The operations of a method or algorithm disclosed herein may be embodied in a processor-executable software module which may be stored on a non-transitory computer-readable medium or processor-readable medium. Non-transitory computer-readable and processor-readable media may be any available storage media that may be accessed by a computer or processor. By way of example, and not limitation, such non-transitory computer-readable media may include RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the present invention. Thus, the present invention is not intended to be limited to the aspects shown herein but is to be accorded the widest scope consistent with the principles and novel features disclosed herein.

What is claimed is:

1. A method for graphically displaying time applied to performing a task comprising:
receiving by a productivity processor time data with respect to a client task, wherein the time data measures an amount of work performed by one or more workers on the client task as the client task is being performed;
sending by the productivity processor instructions to a graphics processor to create a graphical representation of the work being performed on the client task;
receiving by the productivity processor the graphic representation of the work being performed from the graphics processor:
communicating by the productivity processor a first message by the productivity processor to a client device that the work on the client task is being performed when the time data is received by the productivity processor; and
communicating to the client device by the productivity processor a first link to the graphical representation of the work being performed.

2. The method of claim 1 further comprising:
generating by the graphics processor a graphical representation of an accrued time spent by the one or more workers on the client task concurrently with the performance of the client task;
receiving by the productivity processor the graphical representation of the accrued time from the graphics processor; and
communicating to the client device by the productivity processor a second link to the graphical representation of the accrued time.

3. The method of claim 2, wherein the first message further comprises a static graphical object representing the accrued time as of the time the first message is communicated.

4. The method of claim 2 further comprising:
receiving by the productivity processor a time budget for the client task, wherein the time budget data represents an amount of time budgeted for the client task;
sending by the productivity processor instructions to the graphics processor to create a graphical representation of the time budget for the client task;
receiving by the productivity processor the graphical representation of the time budget from the graphics processor; and
updating by the productivity processor the first link to the graphical representation of the work being performed to include the graphical representation of the time budget.

5. The method of claim 4 further comprising:
receiving by the productivity processor a first alerting rule, wherein the alerting rule measures the time budget against the accrued time; and
sending by the productivity processor an alert message when the accrued time is greater than or equal to the time budget.

6. The method of claim 1 further comprising:
receiving by the productivity processor a billing rate associated with each of the one or more workers performing work on the client task;
determining by the productivity processor an accrued monetary cost of the accrued time using the billing rate associated with each of the one or more workers; and
communicating to the client device by the productivity processor a third link to a graphical representation of the accrued monetary cost.

7. The method of claim 6 further comprising:
receiving by the productivity processor a cost budget for the client task;
sending by the productivity processor instructions to the graphics processor to create a graphical representation of the cost budget for the client task;
updating by the productivity processor the first link to the graphical representation of the work being performed to include the graphical representation of the cost budget.

8. The method of claim 7 further comprising:
receiving by the productivity processor a second alerting rule, wherein the second alerting rule measures the cost budget against the accrued monetary cost; and
sending by the productivity processor an alert message when the accrued monetary cost is greater than or equal to the cost budget.

9. The method of claim 1 further comprising:
receiving by the productivity processor additional time data with respect to an additional client task, wherein the additional time data measures an amount of work performed by one or more workers on the additional client task as the additional client task is being performed;
sending by the productivity processor instructions to a graphics processor to create a graphical representation of the work being performed on the additional client task;
communicating by the productivity processor a second message by the productivity processor to the client device that the work on the additional client task is being performed when the additional time data is received by the productivity processor; and
updating by the productivity processor the first link to the graphical representation of the work being performed to include the graphical representation of work being performed on the additional client task.

10. The method of claim 1 further comprising;
receiving by the productivity processor a list of workers authorized to perform work on the client task; and
allowing by the productivity processor a worker to enter time data for the client task when the worker is on the list of authorized workers.

11. A system for graphically displaying time applied to performing a task comprising:
a memory comprising computer readable software instructions;
a productivity processor coupled to the memory and configured to receive first software instructions from the memory; and
a graphics processor coupled to the memory and configured to receive second software instructions from the memory,
wherein, the first software instructions when executed by the productivity processor cause the productivity processor to perform operations comprising:
receiving time data with respect to a client task, wherein the time data measures an amount of work performed by one or more workers on the client task as the client task is being performed; and
sending instructions to the graphics processor to create a graphical representation of the work being performed on the client task;
wherein, the second software instructions when executed by the graphics processor cause the graphics processor to perform operations comprising generating a graphical representation of the work being performed concurrently with the performance of the client task, and
wherein the first software instructions when executed by the productivity processor cause the productivity processor to perform operations further comprising:
receiving the graphic representation of the work being performed from the graphics processor:
communicating a first message to a client device that the work on the client task is being performed when the time data is received by the productivity processor; and
communicating to the client device a first link to the graphical representation of the work being performed.

12. The system of claim 11,
wherein the second software instructions when executed by the graphics processor cause the graphics processor to perform operations further comprising generating a graphical representation of an accrued time spent by the one or more workers on the client task concurrently with the performance of the client task; and
wherein the first software instructions when executed by the productivity processor cause the productivity processor to perform operations further comprising:
receiving the graphical representation of the accrued time from the graphics processor: and
communicating to the client device a second link to the graphical representation of the accrued time.

13. The system of claim 12, wherein the first message further comprises a static graphical object representing the accrued time as of the time the first message is communicated.

14. The system of claim 12,
wherein the first software instructions when executed by the productivity processor cause the productivity processor to perform operations further comprising:
receiving a time budget for the client task, wherein the time budget data represents an amount of time budgeted for the client task; and
sending instructions to the graphics processor to create a graphical representation of the time budget for the client task,
wherein, the second software instructions when executed by the graphics processor cause the graphics processor to perform operations comprising generating the graphical representation of the time budget for the client task, and
wherein the first software instructions when executed by the productivity processor cause the productivity processor to perform operations further comprising updating the first link to the graphical representation of the work being performed to include the graphical representation of the time budget.

15. The system of claim 14, wherein the first software instructions when executed by the productivity processor cause the productivity processor to perform operations further comprising:
receiving by the productivity processor a first alerting rule, wherein the alerting rule measures the time budget against the accrued time; and
sending by the productivity processor an alert message when the accrued time is greater than or equal to the time budget.

16. The system of claim 11, wherein the first software instructions when executed by the productivity processor cause the productivity processor to perform operations further comprising:
receiving a billing rate associated with each of the one or more workers performing work on the client task;
determining an accrued monetary cost of the accrued time using the billing rate associated with each of the one or more workers; and
sending instructions to the graphics processor to create a graphical representation of the accrued monetary cost for the client task,
wherein, the second software instructions when executed by the graphics processor cause the graphics processor to perform operations comprising generating the graphical representation of the accrued monetary cost for the client task, and
wherein the first software instructions when executed by the productivity processor cause the productivity processor to perform operations further comprising communicating to the client device a third link to a graphical representation of the accrued monetary cost.

17. The system of claim 16, wherein the first software instructions when executed by the productivity processor cause the productivity processor to perform operations further comprising:
receiving a cost budget for the client task; and
sending instructions to the graphics processor to create a graphical representation of the cost budget for the client task;
wherein, the second software instructions when executed by the graphics processor cause the graphics processor to perform operations comprising generating the graphical representation of the cost budget for the client task, and
wherein the first software instructions when executed by the productivity processor cause the productivity processor to perform operations further comprising updating the first link to the graphical representation of the work being performed to include the graphical representation of the cost budget.

18. The system of claim 17, wherein the first software instructions, when executed, cause the productivity processor to perform operations further comprising:
receiving a second alerting rule, wherein the second alerting rule measures the cost budget against the accrued monetary cost; and
sending an alert message when the accrued monetary cost is greater than or equal to the cost budget.

19. The system of claim 11, wherein the first software instructions, when executed, cause the productivity processor to perform operations further comprising:
receiving additional time data with respect to an additional client task, wherein the additional time data measures an amount of work performed by one or more workers on the additional client task as the additional client task is being performed; and
sending instructions to the graphics processor to create a graphical representation of the work being performed on the additional client task,
wherein, the second software instructions when executed by the graphics processor cause the graphics processor to perform operations comprising generating the graphical representation of the graphical representation of the work being performed on the additional client task, and
wherein the first software instructions when executed, by the productivity processor cause the productivity processor to perform operations further comprising:
communicating a second message to the client device that the work on the additional client task is being performed when the additional time data is received by the productivity processor; and
updating the first link to the graphical representation of the work being performed to include the graphical representation of work being performed on the additional client task.

20. The system of claim 11, wherein the first software instructions when executed by the productivity processor cause the productivity processor to perform operations further comprising:
receiving a list workers authorized to perform work on the client task; and
allowing a worker to enter time data for the client task when the worker is on the list of authorized workers.

21. A non-transitory computer-readable storage medium having stored thereon processor executable instructions configured to cause a productivity processor to perform operations comprising:
receiving time data with respect to a client task, wherein the time data measures an amount of work performed by one or more workers on the client task as the client task is being performed; and
sending instructions to a graphics processor to create a graphical representation of the work being performed on the client task; and
communicating a first message to a client device that the work on the client task is being performed when the time data is received by the productivity processor; and
communicating to the client device a first link to the graphical representation of the work being performed.

22. The non-transitory computer-readable storage medium of claim 21,
wherein the stored processor executable instructions are configured to cause the graphics processor to perform operations comprising generating a graphical representation of an accrued time spent by the one or more workers on the client task concurrently with the performance of the client task; and
wherein the stored processor executable instructions are configured to cause the productivity processor to perform further operations comprising communicating to the client device a second link to the graphical representation of the accrued time generated by the graphics processor.

23. The non-transitory computer-readable storage medium of claim 21, wherein the first message further comprises a static graphical object representing the accrued time as of the time the first message is communicated.

24. The non-transitory computer-readable storage medium of claim 22, wherein the stored processor executable instructions are configured to cause the productivity processor to perform further operations comprising:
receiving a time budget for the client task, wherein the time budget data represents an amount of time budgeted for the client task;
sending instructions to the graphics processor to create a graphical representation of the time budget for the client task; and
updating the first link to the graphical representation of the work being performed to include the graphical representation of the time budget.

25. The system of claim 24, wherein the stored processor executable instructions are configured to cause the productivity processor to perform further operations comprising:
receiving by the productivity processor a first alerting rule, wherein the alerting rule measures the time budget against the accrued time; and
sending by the productivity processor an alert message when the accrued time is greater than or equal to the time budget.

26. The system of claim 21, wherein the stored processor executable instructions are configured to cause the productivity processor to perform further operations comprising:
receiving a billing rate associated with each of the one or more workers performing work on the client task;
determining an accrued monetary cost of the accrued time using the billing rate associated with each of the one or more workers; and
communicating to the client device a third link to a graphical representation of the accrued monetary cost.

27. The system of claim 26, wherein the stored processor executable instructions are configured to cause the productivity processor to perform further operations comprising:
receiving a cost budget for the client task;
sending instructions to the graphics processor to create a graphical representation of the cost budget for the client task;
updating the first link to the graphical representation of the work being performed to include the graphical representation of the cost budget.

28. The system of claim 27, wherein the stored processor executable instructions are configured to cause the productivity processor to perform further operations comprising:
receiving a second alerting rule, wherein the second alerting rule measures the cost budget against the accrued monetary cost; and
sending an alert message when the accrued monetary cost is greater than or equal to the cost budget.

29. The system of claim 21, wherein the stored processor executable instructions are configured to cause the productivity processor to perform further operations comprising:
receiving additional time data with respect to an additional client task, wherein the additional time data measures an amount of work performed by one or more workers on the additional client task as the additional client task is being performed;
sending instructions to the graphics processor to create a graphical representation of the work being performed on the additional client task;
communicating a second message to the client device that the work on the additional client task is being performed when the additional time data is received by the productivity processor; and
updating the first link to the graphical representation of the work being performed to include the graphical representation of work being performed on the additional client task.

30. The system of claim 21, wherein the stored processor executable instructions are configured to cause the productivity processor to perform further operations comprising:
receiving a list workers authorized to perform work on the client task; and
allowing a worker to enter time data for the client task when the worker is on the list of authorized workers.
